(19) United States
(12) Patent Application Publication
(10) Pub. No.: US 2009/0058178 A1
(43) Pub. Date: Mar. 5, 2009

(54) Photoluminescent Element for Wheel

(75) Inventors: Jesse N. Palmer, Greenville, NC (US); Barry L. Allen, Farmville, NC (US); Joseph Bloomfield, Diamond Bar, CA (US)

Correspondence Address: COATS & BENNETT, PLLC, 1400 Crescent Green, Suite 300, Cary, NC, 27518, US

(73) Assignee: LUNASEE LLC, Greenville, NC (US)

(21) Appl. No.: 12/199,874

(22) Filed: Aug. 28, 2008

Related U.S. Application Data
(60) Provisional application No. 60/968,580, filed on Aug. 29, 2007.
(60) Provisional application No. 61/020,035, filed on Jan. 9, 2008.

(51) Int. Cl. B60B 7/00

(52) U.S. Cl. 301/37.108

(57) ABSTRACT

Photoluminescent material is mated to a wheel using various approaches. The wheel may have a groove in the rim, with a photoluminescent insert in the groove. The groove may be at any location on the rim, with one advantageous location being on the sidewall radially inward from the brake engaging area. The wheel may have a photoluminescent ribbon mounted thereto, not in a protective groove. The ribbon may be mounted to a lateral side of the wheel's spokes and/or mounted in the “plane” of the spokes between the spokes. The wheel may have an attachment secured to one or more spokes, with the attachment having photoluminescent material. The attachment may have a main body with a groove therein, with the main body being bendable to be substantially conformable to a curvature of the rim. The attachment may abut a surface of the rim.

This application claims benefit of U.S. Provisional Application No. 60/968,580, filed 29 Aug. 2007, and U.S. Provisional Application No. 61/020,035, filed 9 Jan. 2008, both of which are incorporated herein by reference.

### BACKGROUND

The present idea relates to providing a wheel with one or more photoluminescent elements.

Photoluminescent (PL) pigments excite under exposure to light, resulting in a sustained glow after the removal of the light source. The light source may be either naturally occurring sunlight or may be from a an appropriate artificial emitter, such as automobile headlights, a flashlight, or an ultraviolet LED.

Including PL elements on a wheel, particularly a bicycle wheel, may increase the visibility of the wheel in low light conditions. The PL material may be excited from being exposed to an automobile's headlights, and continue to glow despite leaving the direct field of the headlights. Alternatively, the PL material may be excited from being exposed to a UV emitter that is aimed at the wheel. Examples of this latter approach are found in U.S. Pat. No. 7,001,051 and U.S. Patent Application Publication No. 2006/0158868.

While some approaches to mating PL elements to a wheel have been proposed, they have not proven satisfactory for all situations. As such, there remains a need for alternative approaches to mating PL elements to a wheel.

### SUMMARY

The present invention, in general, provides various approaches to mating PL material to a wheel. In one embodiment, a wheel comprises a wheel frame having an axis of rotation and a rim circumferentially surrounding and spaced from the axis. There is a groove in the rim. An insert is mounted to the rim and disposed in the groove. The insert comprises photoluminescent material and may advantageously be rectilinear in cross-section. The insert may be removably mounted to the rim and/or may be nested in the groove so as to not extend outward therefrom. The groove may be at any location on the rim, with one advantageous location being on the sidewall radially inward from the brake engaging area.

In another embodiment, a wheel comprises a wheel frame having an axis of rotation and a rim circumferentially surrounding and spaced from the axis. A ribbon is mounted to the rim; with the ribbon comprising photoluminescent material. The ribbon may be a self-adhesive tape. The ribbon may be mounted to a lateral side of the wheel's spokes and/or mounted in the “plane” of the spokes between the spokes. The ribbon may have a cross-sectional shape that has sides that slope toward each other in a direction away from the rim.

In another embodiment a wheel comprises a wheel frame having an axis of rotation and a rim circumferentially surrounding and spaced from the axis. The wheel further comprises a plurality of spaced apart spokes extending inward from and supporting the rim. An attachment is mounted to one or more of the spokes, adjacent the rim, with the attachment comprising photoluminescent material and advantageously being flexible. The spokes may include nipples connecting the spokes to the rim, with the attachment mounted to one or more of the nipples. The attachment may circumferentially extend between a plurality of the spokes, if desired. The attachment may include a groove, with an insert disposed in the groove and comprising photoluminescent material. The attachment may comprise a main body having the groove therein, with the main body being bendable to be substantially conformable to a curvature of the rim. In some embodiments, the attachment abuts a surface of the rim.

The various aspects of the various illustrative embodiments of the invention may be used alone or in any combination, as is desired.

### BRIEF DESCRIPTION OF THE DRAWINGS

FIG. 1 shows a side view of a bicycle employing at least one embodiment of the present invention.

FIG. 2 shows a partial perspective view of a bicycle wheel according to one embodiment of the present invention.

FIG. 3 shows a cross-sectional view of a rim of the embodiment of FIG. 2.

FIG. 4 shows a cross-sectional view of an alternative rim embodiment.

FIG. 5 shows a cross-sectional view of a photoluminescent material containing insert according to one embodiment.

FIG. 6 shows a ribbon comprising phosphorescent material secured to a rim on the lateral sides of the spokes.

FIG. 7 shows one embodiment of a photoluminescent material containing spoke attachment.

FIG. 8 shows another embodiment of a photoluminescent material containing spoke attachment.

FIG. 9 shows another embodiment of a photoluminescent material containing spoke attachment, with the photoluminescent material disposed in a groove of the attachment.

### DETAILED DESCRIPTION

Some aspects of the present invention find particular advantageous application in conjunction with bicycle wheels. As such, the following discussion will be in the context of bicycles and bicycle wheels; however, it should be understood that such is an illustrative convenience and is not intended to be limiting.

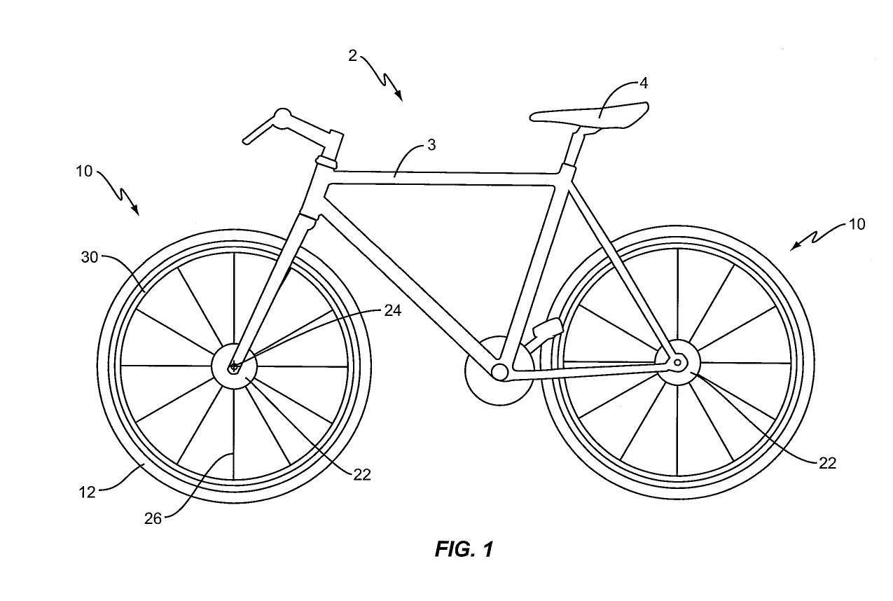

A representative bicycle is shown in FIG. 1. As is conventional, the bicycle 2 includes a frame 3 that supports a seat 4 for the rider, with two wheels 10 coupled to the frame for rotation about respective rotational axes. As discussed further below, the photoluminescent material associated with the present invention may be used with one, or advantageously, both wheels, and on one or both lateral sides thereof. Advantageously, the photoluminescent material is outwardly exposed on the lateral sides of the wheel so that it can be charged by the headlights of passing vehicles, or by a suitable photo-charging device (e.g., UV LED emitter) mounted to the bicycle. For further information on various approaches to charging the photoluminescent material see U.S. Pat. No. 7,001,051 and U.S. Patent Application Publication Nos. 2006/0158868 and 2007/0285938, all of which are incorporated herein by reference.

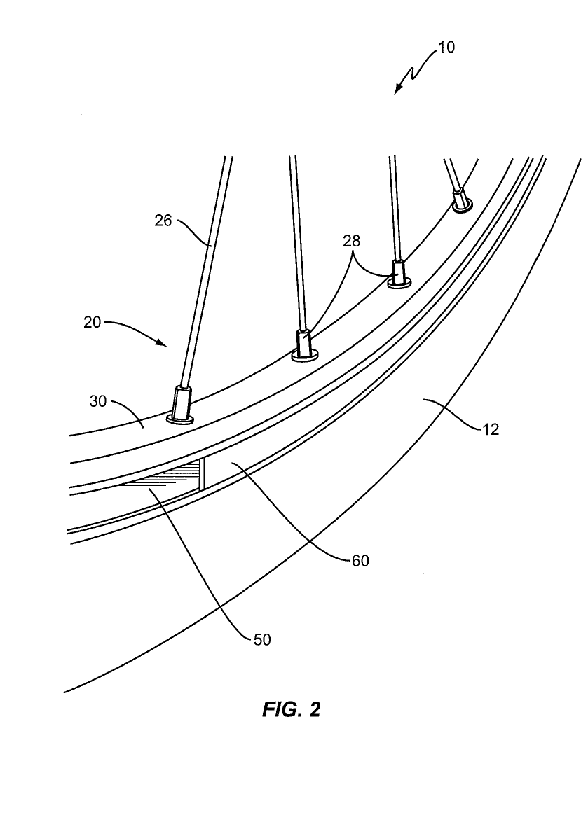

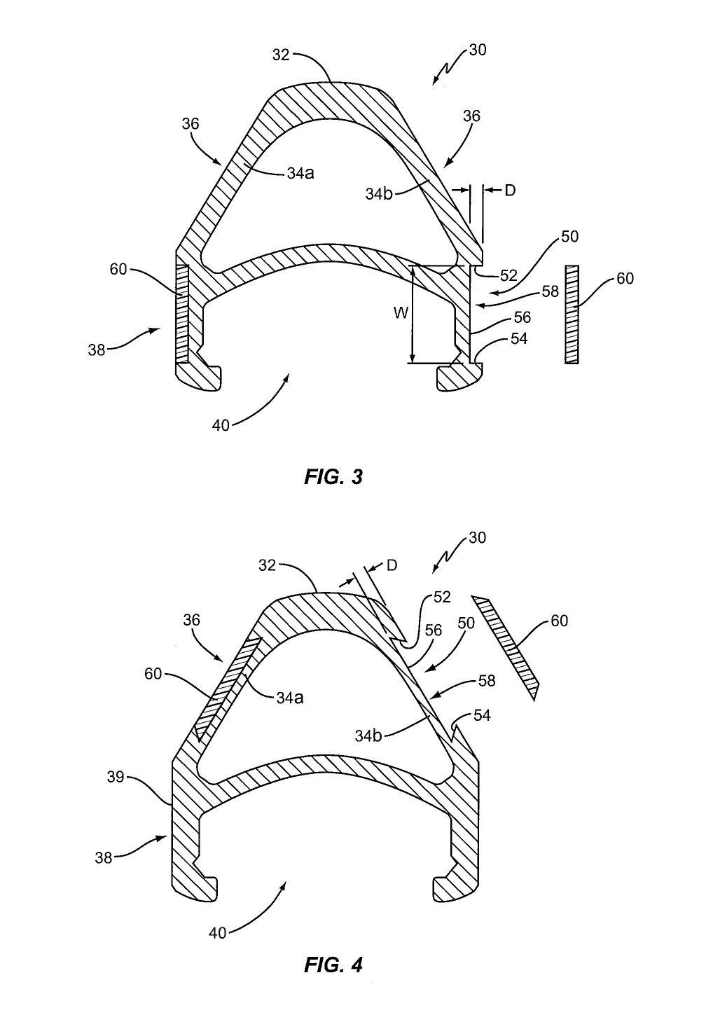

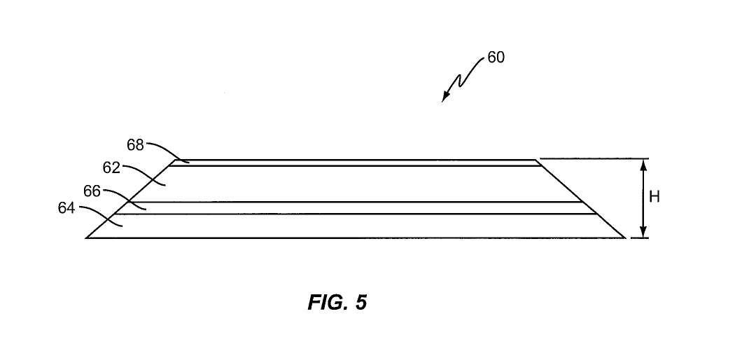

The relevant PL material may be provided as one or more PL segments that are disposed in corresponding recessed area(s) on the wheel 10. For example, FIG. 2 shows a bicycle wheel 10 that includes a wheel frame 20 with a tire 12 thereon. The wheel frame 20 includes a central hub 22, a plurality of spokes 26, and a rim 30. The central hub 22 may take any form known in the art and provides a means for rotatably mounting the wheel 10 on the bicycle's frame 3 in a conventional fashion. The spokes 26 may also take any form known in the art and function to supportably connect the hub to the rim 30. The rim 30 conventionally has a somewhat U-shape cross section, with a proximal wall 32 disposed inward and generally transverse to the spokes 26, left and right sidewalls 34a,34b, and a outwardly disposed—and outwardly facing—circumferential channel 40. As shown in FIG. 3, the left and right rim sidewalls 34a, 34b are advantageously disposed generally symmetrically relative to a plane that is normal to the corresponding rotational axis 24, and are advantageously mirror images of each other. The sidewalls 34a, 34b may have an inner section 36 disposed closer to the proximal wall 32 and an outer section 38 disposed farther from the proximal wall 32. The outer sections 38 are advantageously disposed generally parallel to each other and provide a brake engaging area 39 for engagement with the brake pads associated with the wheel 10. The inner sections 36 are disposed at an angle to the outer sections 38 and therefore are oriented at an angle to the rotational plane. The central hub 22, spokes 26, and rim 30 may be made from any suitable material, such as aluminum, titanium, polymers (with or without fiber reinforcement), or other materials known in the art. The tire 12 mates to the rim 30 at the circumferential channel 40 in any conventional fashion.

The rim 30 includes circumferential groove 50 on at least one lateral side, and advantageously both lateral sides. The groove 50 may be located in either the outer section 38 (FIG. 3) or the inner section 36 (FIG. 4). If the groove 50 is in the outer section 38, the groove 50 is advantageously located in a region thereof that is not in the brake engaging area 39. The groove 50 advantageously has a width W larger than its depth D. The cross-sectional shape of the groove 50 may vary. In some embodiments, such as that shown in FIG. 3, the groove 50 has a rectilinear cross-section with parallel inner and outer boundary walls 52, 54 bracketing a base wall 56 and intersecting at a 90° angle. Thus, in this embodiment, the groove opening 58 is the same size as the base wall 56. In other embodiments, such as that shown in FIG. 4, the groove opening 58 is smaller than the base wall 56 because the inner and outer boundary walls 52, 54 are angled toward each other. While the inner and outer boundary walls 52,54 are illustrated as being smooth, it should be understood that these walls 52,54 may have recesses or other features (e.g., dimples), as is desired. The groove 50 advantageously extends a full 360° about the wheel's rotational axis 24. However, in some embodiments, there may be a plurality of distinct groove segments that are arranged to form an intermittent groove 50 rather than a continuous groove 50.

A photoluminescent insert 60 is disposed in the groove 50 and suitably mated to the rim 30. The insert 60 may comprise a self-adhesive tape 70 that includes a suitable photoluminescent material, such as strontium aluminate, zinc sulfide, or other know photoluminescent material. Typically, the photo-luminescent material is in the form of layer of a binder material 62 (such as urethanes, resins, epoxies, low density polyurethanes, triglycidyl isocyanurate (TGIC) epoxy, or polyureas) mixed with the photoluminescent material itself. This layer 62 may have any suitable thickness, such as two millimeters. In some embodiments, a layer of white material 66, such as white pigment and/or materials known as optical brighteners, may be sandwiched between a layer of photoluminescent material and the tape's adhesive layer 64. In addition, a suitable transparent protective layer 68 may be applied over the photo-luminescent material for environmental protection. The tape 70, with the adhesive backing exposed, is placed in the groove 50 so that the adhesive layer 64 bonds to the base wall 56 to secure the tape in groove 50. Note that the tape 70 may or may not require relief cuts (not shown) to accommodate the curving path of the groove 50, depending on the particular materials involved. The cross-sectional shape of the insert 60 should complement the cross-sectional shape of the groove 50. Thus, if the groove is generally rectilinear, the insert 60 should likewise be rectilinear. Or, if the groove 50 has inner and outer boundary walls 52, 54 are angled toward each other, the insert 60 should have a corresponding cross-section to as to allow the insert 60 to be dove-tailed into the groove 50. Other retaining profiles may alternatively be used, such as tongue and groove and the like.

In other embodiments, the photoluminescent insert 60 is not a tape 70, but instead takes the form of a less flexible solid insert 60 that is glued, slid, or snap-fitted into the groove 50. In still other embodiments, the photoluminescent insert 60 is not a solid contiguous element when initially mated to the groove 50, but is instead applied as a liquid/gel (e.g., epoxy), powder coat pigments, and/or paint, that cures (e.g., dries) once applied to the groove 50. Any of these arrangements may also employ the white 66 and/or protective layers 68, as is desired.

The photoluminescent insert 60 advantageously fills the groove 50 from inner boundary wall 52 to outer boundary wall 54. While not required, the photoluminescent insert 60 advantageously has a height H that this not more than, and more advantageously, less than, the groove depth D. This relationship allows the insert 60 to be nested inside the groove 50 and not protrude therefrom. A flush or slightly recessed positioning of the exposed surface of the photoluminescent insert 60 helps prevent edge peeling of the insert 60. A slightly recessed positioning of the exposed surface of the photoluminescent insert 60 also allows the associated brake pad to be applied to the rim 30 without detrimentally engaging the insert 60 in embodiments of the rim 30 where the groove 50 is located in the outer section 38 of sidewalls 34a,34b.

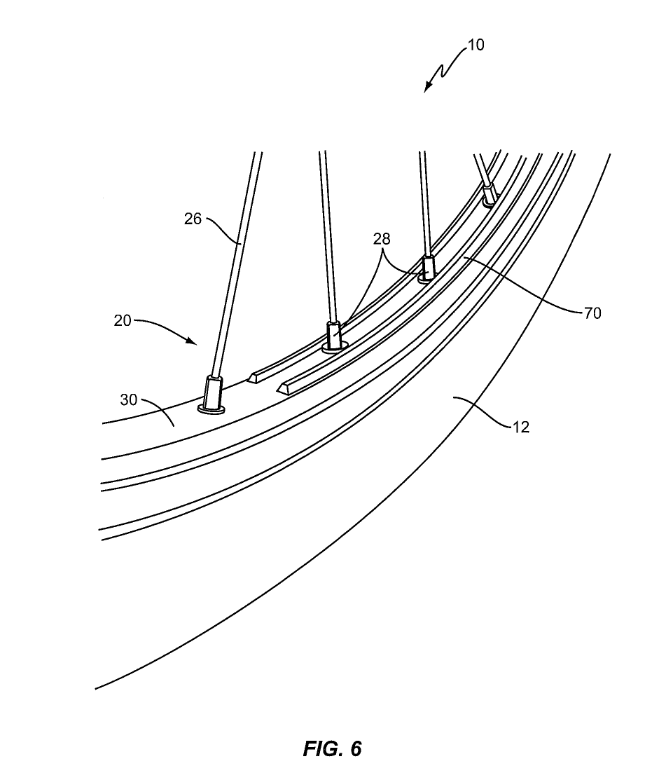

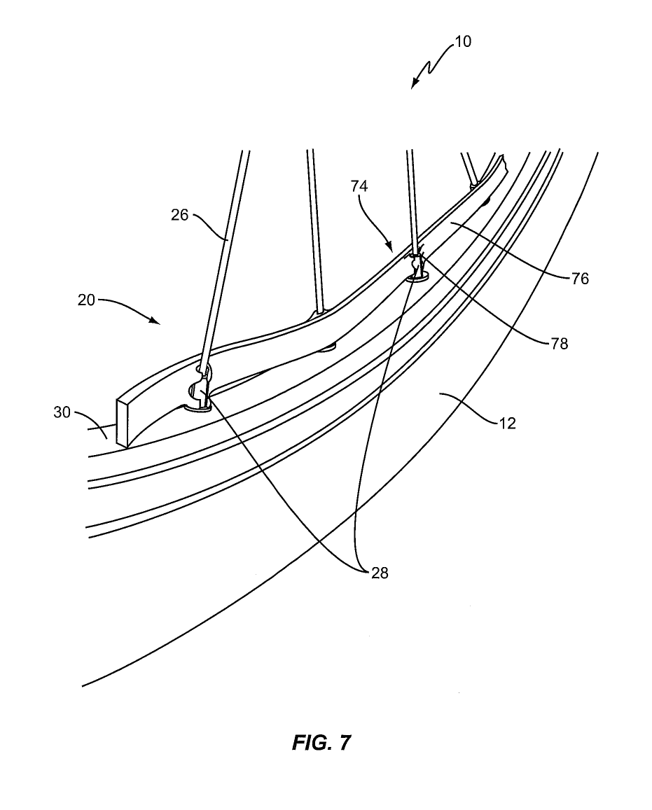

The discussion above has assumed that the photoluminescent material is disposed in the groove 50 as an insert 60. However, in some embodiments, the photoluminescent material is not disposed in a groove 50, but is instead adhered to an exposed portion of the rim sidewalls 34a,34b and/or the proximal wall 32. See FIG. 6. The photoluminescent material may be in the form of a ribbon of material, e.g., tape 70, and may or may not have relief cuts to accommodate the curving path of the rim 30, depending on the particular materials involved. The tape 70 may be disposed to one side of spokes 26, advantageously with another tape 70 disposed on the other lateral side of spokes 26. Such tape 70 may extend approximately 360° around the wheel's rotational 24, or may extend only partially around, such as only 120°; if so, there may advantageously be additional tape segments 70 on the rim (optionally overlapping) so as to form a complete or intermittent ring around the wheel's rotational axis 24. Alternatively, the tape 70 may be disposed in the “plane” of the spokes, inbetween adjacent spokes 26. In this latter embodiment, there are advantageously a plurality of such tape segments 70 disposed in the gaps between each spoke 26 so as to form an intermittent ring in side view. In some embodiments, the tape 70 is not self-adhesive, but instead is attached to the rim 30 using an initially separate adhesive material, which may be “double-stick” tape as is desired. Alternatively, the photoluminescent material may not be in tape form per se, but may instead take the form of a somewhat flexible ribbon of material that may be considered too rigid to be a tape.

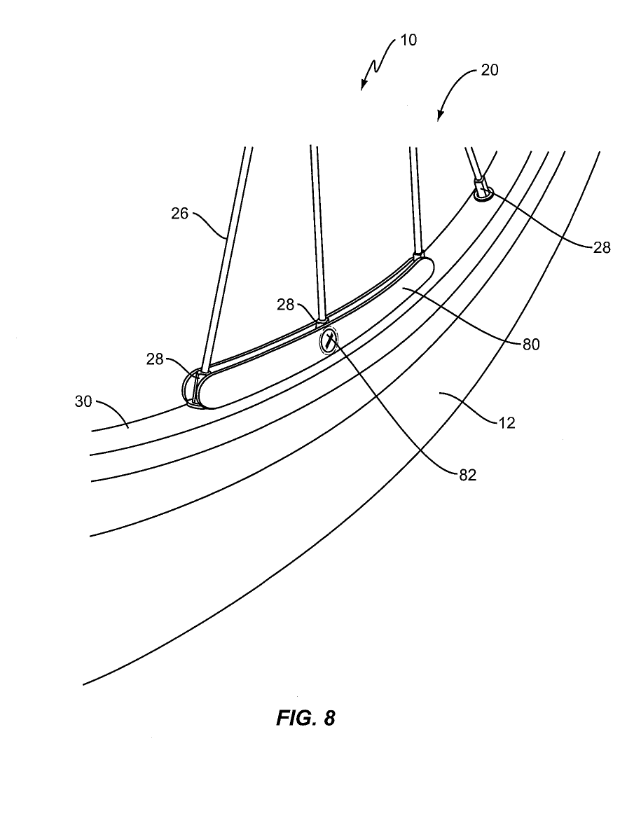

In other embodiments, the photoluminescent material is not mounted to the rim 30, but is instead mounted to the spokes 26. For example, FIG. 7 shows an attachment 74 that contains photoluminescent material that is mounted to several adjacent spokes 26. The attachment 74 is in the form a separate and distinct ribbon or strip of material that includes mounting protrusions 78 on alternating sides thereof. The mounting protrusions 78 are sized and configured to securely snap-fit onto corresponding spokes 26, proximate where the spoke 26 connects to the rim 30, such as at the nipples 28. This location of the photoluminescent material—radially outward at or almost at the rim 30—provides the most photoluminescent material for a given size wheel 10, and also places the photoluminescent material in visual proximity to any reflective material that may be present in the rim 30 and/or tire 12. The attachment 74 may be woven between all or most of the spokes 26 so as to extend approximately 360° about the wheel's rotational axis 24. Alternatively, a plurality of attachments 74 may be employed to make an intermittent ring of photoluminescent material in side view.

FIG. 8 shows another embodiment where a photoluminescent attachment 80 is attached to a single spoke 26, but spans the two adjacent gaps between the spokes 26. The attachment takes the form of two ribbons or strips that contain photoluminescent material that are disposed on opposite lateral sides of the plane of the spokes 26, but that are joined together by fastener 82. In this embodiment the attachment 80 clamps to the spoke 26, such as by tightening connecting fastener 82. As with the attachment 74 of FIG. 6, the attachment 80 may one of series of attachments 80 that form an intermittent or complete ring of photoluminescent material in side view, or a single attachment 80 itself may extend approximately 360° about the wheel's rotational axis 24. Note that the attachment is 80 advantageously slightly curved to correspond to the curvature of the associated rim 30. The attachment 80 may be made with such a curvature, or a similar curvature, and/or may be made of a bendable material that can be bent to the appropriate shape.

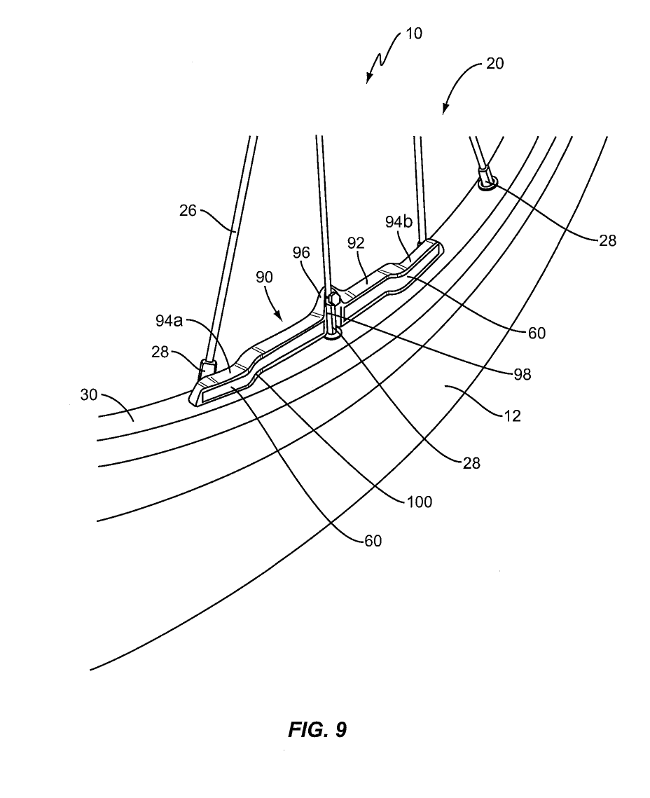

The embodiments of FIGS. 7-8 have employed photoluminescent material that forms the main body of, and particularly the lateral-most surface of, the attachments 74,80. However, in some embodiments, the main body of the attachment is not photoluminescent and the photoluminescent material is disposed in a groove in the attachment. FIG. 9 shows an attachment 90 that has a main body 92 formed of a non-photoluminescent material, such as conventional plastics, with the photoluminescent material disposed in a groove 100. The attachment 90 includes left and right arms 94a, 94b and an intervening mounting section 96. The mounting section 96 includes a vertically running slot 98 for accepting a spoke 26 and the associated nipple 28 (nut for adjusting tension of the spokes 26). A screw or other fastener engages the main body 92 of the attachment 90 just slightly offset from the slot 98, with a portion of the fastener overhanging slot 98 so as to clamp the attachment 90 to the spoke 26 when the fastener is tightened. In some embodiments, the attachment 90 may mount to multiple spokes 26, such as by having multiple slots 98. Either way, the mounting of the attachments 90 to the spoke(s) 26 may be by any conventional means, including screws, bolts, snaps, or any other suitable mounting approach. The arms 94a,94b of attachment 90 include a groove 100, which may take any of the forms discussed above. An insert 60 comprising photoluminescent material is disposed in groove 100. The insert 60 may take any of the forms discussed above, such as being a tape 70, or a less flexible material, or a cured-in-place photoluminescent material. At least the end portions of the arms 94a,94b are advantageously flexible, so that one universal size of attachment 90 may be easily made to conform to the various conventional size wheels 10. This type of attachment 90 may be attached anywhere along the spoke 26, but is advantageously mounted to the spoke 26 proximate where the spoke 26 mates to the rim 30, such that the arms 94a,94b abut the rim's proximal wall 32.

The photoluminescent material used in the present invention may be any suitable photoluminescent material and may be of any desired color or combination of colors.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A wheel comprising:
a wheel frame having an axis of rotation and a rim circumferentially surrounding and spaced from the axis;
a groove in the rim;
an insert mounted to said rim and disposed in the groove, the insert comprising photoluminescent material.

2. The wheel of claim 1 wherein the insert is removably mounted to said rim.

3. The wheel of claim 1 wherein the insert is nested in the groove so as to not extend outward therefrom.

4. The wheel of claim 1 wherein the rim includes sidewalls; wherein the sidewalls include first and second portions with the first portion is disposed closer to the axis than the second portion; wherein the groove is disposed in the first portion.

5. The wheel of claim 1 wherein the insert is substantially rectilinear in cross-section.

6. The wheel of claim 1 wherein the insert comprises a tape.

7. The wheel of claim 1 wherein the groove has a non-rectilinear cross-section, and wherein the insert has a corresponding cross-section such that the insert is received in the groove in a dovetail fashion.

8. A wheel comprising:
a wheel frame having an axis of rotation and a rim circumferentially surrounding and spaced from the axis;
a ribbon mounted to the rim; the ribbon comprising photoluminescent material.

9. The wheel of claim 8 wherein the ribbon comprises a self-adhesive tape.

10. The wheel of claim 8 wherein said wheel frame comprises a plurality of spaced apart spokes extending inward from and supporting the rim;
wherein the ribbon is mounted to a lateral side of the spokes.

11. The wheel of claim 8 wherein the ribbon has cross-sectional shape having sides that slope toward each other in a direction away from the rim.

12. A wheel comprising:
a wheel frame having an axis of rotation and a rim circumferentially surrounding and spaced from the axis; the wheel further comprising a plurality of spaced apart spokes extending inward from and supporting the rim;
an attachment mounted to one or more of the spokes; the attachment comprising photoluminescent material;
the attachment disposed adjacent the rim.

13. The wheel of claim 12 wherein the spokes include nipples connecting the spokes to the rim; wherein attachment is mounted to one or more of the nipples.

14. The wheel of claim 12 wherein the attachment circumferentially extends between a plurality of the spokes.

15. The wheel of claim 12 further comprising a fastener operative to clamp the attachment to the one or more spokes.

16. The wheel of claim 12 wherein the attachment comprises a groove; further comprising an insert disposed in the groove and comprising photoluminescent material.

17. The wheel of claim 16 wherein the attachment comprises a slot; one of the spokes extending through the slot.

18. The wheel of claim 16 wherein the groove has a depth and the insert has a thickness less than the depth so groove so as to not extend outward from the groove.

19. The wheel of claim 16 wherein the attachment comprises a main body having the groove therein; wherein the main body is bendable to substantially conform to a curvature of the rim.

20. The wheel of claim 16 wherein the insert comprises a material cured in the groove.

21. The wheel of claim 16 wherein the attachment abuts a surface of the rim.

22. The wheel of claim 16 wherein the attachment is bendable to substantially conform to a curvature of the rim.
